(19) United States
(12) Patent Application Publication
(10) Pub. No.: US 2025/0327710 A1
(43) Pub. Date: Oct. 23, 2025

(54) PRESSURE SENSING POLYMER

(71) Applicants: LENORE RASMUSSEN, HINGHAM, MA (US); CALUM BRIGGS, SOMERVILLE, MA (US); TIANYU CHENG, FRAMINGHAM, MA (US)

(72) Inventors: LENORE RASMUSSEN, HINGHAM, MA (US); CALUM BRIGGS, SOMERVILLE, MA (US); TIANYU CHENG, FRAMINGHAM, MA (US)

(21) Appl. No.: 19/054,292

(22) Filed: Feb. 14, 2025

Related U.S. Application Data
(63) Continuation-in-part of application No. 17/238,910, filed on Apr. 23, 2021, now abandoned.

(51) Int. Cl. G01L 9/00; C08J 3/24; C08J 3/28; G01L 1/20

(52) U.S. Cl. CPC G01L 9/0058; C08J 3/24; C08J 3/28; G01L 1/205

(57) ABSTRACT

This invention describes a novel, superior pressure sensor, pressure sensing device, or pressure sensing system. This can act as a pressure sensor, device, or system for a fingertip-like tactile sensor or skin, comprising hydrophilic monomer(s), cross-linked with appropriate cross-linking agent(s), with appropriate solvent(s) or diluent(s), electrolyte(s), electrodes, and coating(s). This sensor is extremely sensitive, yet is also robust and has a wide pressure range. The sensor can be made in a variety of shapes and sizes as desired. The sensor can be used for a wide range of applications, from robotic grippers and prosthetic fingers and hands to health and medical monitoring and sports equipment, and other pressure sensing applications.

### CROSS REFERENCE TO RELATED APPLICATIONS

This application claims the benefit under 35 U.S.C. § 119(e) of U.S. Provisional Application 63/014,494, filed Apr. 23, 2020, U.S. Provisional Application 63/028,094, filed May 21, 2020, U.S. Provisional Application 63/092,663, filed Oct. 16, 2020, and U.S. Provisional Application 63/168,053, filed Mar. 30, 2021, the entire contents of which are incorporated by reference.

### TECHNICAL FIELD OF THE INVENTION

This invention relates to a pressure sensor material composition and pressure sensor component architecture.

### BACKGROUND

Pressure sensors, force sensors, and load cells are generally made of a transducer that converts force into a measurable electrical output. Although there are many varieties of pressure sensors, force sensors, and load cells, most of these use strain gauges. Strain gauges send voltage irregularities when under load. The degree of voltage change is converted to digital reading as pressure, force, or weight. Strain gauges can be very precise and accurate, but tend to be limited in the range of their force and pressure detection. Force sensitive resistors (FSRs) are comprised of materials that change resistance when a force, pressure, or mechanical stress is applied. A FSR will vary its resistance depending on how much pressure is being applied to the sensing area. The harder the force, the lower the resistance. FSRs consist of a sensing film, which changes resistance in a predictable manner following application of force to its surface. The sensing film consists of both electrically conducting and non-conducting particles suspended in a polymer matrix. The particles are very small, micron to even nanometer dimensions. Applying a force to the surface of the sensing film causes the particles to touch each other and the conducting electrodes, changing the resistance of the film. Compared to other force sensors, the advantages of FSRs are their very thin size and low cost. FSRs are also simple to use and fairly good at sensing pressure, but they are not very accurate. The main disadvantage of FSRs is their low precision, with measurements that may differ 10% and more, and their range is limited as well, at least compared to the present invention.

Piezoelectric materials convert mechanical energy to electrical energy and vice versa. Piezoelectric materials make very accurate force sensors for small forces, but inherently have a very limited range of pressure or force detection. Most piezoelectric materials are ceramic, and thus are fragile.

Newer tactile sensors, based on light diodes positioned under a transparent flexible polymer matrix that change their reflected light patterns under force or pressure, have been developed by several academic groups and commercialized by companies including GelSight™. These sensors can detect aspects of an object (force, pressure, shape), but are limited by their reliance on a camera and space for its focal length. The size and shape limitations of these sensors limits the ability to ingrate these sensing systems into applications with many mechanical constraints.

Most extremely sensitive sensors are fragile. The pressure sensors in the present invention are extremely sensitive, and though soft and compliant, are also elastic, robust, and have a wide pressure range. Most pressure sensors described as flexible are actually simply bendable. The soft compliant sensors and the sensor materials in the instant invention are truly flexible, compressible, and flexible (stretchable and elastomeric).

### BRIEF DESCRIPTION OF THE DRAWINGS

FIGS. 1A and 1B show objects being handled or manipulated by the pressure sensor in the instant invention, and how force applied to the sensor by the object 1 can be interpreted. In FIG. 1A, the three lines collectively labeled 2 represent electrical signal paths traveling from the flexible conductor 3 on top of the cross-linked polymeric pressure sensor material 4 to the electrodes 5 on the bottom of the sensor. The magnitude and ratio of these signals can be used to determine the deformation of the top layer and therefore the force being applied to the sensor. In FIG. 1B, the three middle electrodes show similar readings, indicating that the object is flat, and the reading from both of the outer channels indicate that the object has a large contact surface area.

FIGS. 2A, 2B show universal testing machine (UTM) mechanical analysis of a pressure sensor using flat platens and a 10-1b load cell in compression for the sensor in the instant invention at 0.25 mm/min to −0.20 mm, where the flat platen of the UTM began to touch the sensor at approximately 2 seconds into the run. While the tests in these figures illustrate particular sensor sensitivity results, it should be understood that the sensitivity of the pressure sensor is not limited to the results illustrated by these tests. FIGS. 2A and 2B shows the expansion of the first 5 seconds of the run. More sophisticated testing procedures may be able to show even more sensitive force and pressure values in these extremely sensitive sensors, that have been able to pick up components of the human heartbeat, the touch of a feather, and other very light touches.

FIGS. 3A, 3B, and 3C show some of the viscoelastic characteristics of the pressure sensors in the instant invention by using UTM mechanical analysis using flat platens in compression. FIG. 3A shows two compression cycles at 2 mm/min to 1.25 mm and release at 2 mm/min to 0 mm. FIG. 3B shows compression at 2 mm/min to 1.25 mm, hold for 60 sec, and quick release at 25 mm/min back to original position. FIG. 3C shows compression at 5 mm/min to 1.25 mm followed by quick release at 25 mm/min to 0 mm. This is just a small snapshot of some of the test methods that can be performed on the sensors. For comparison, FIG. 3D shows the same UTM analyzes to a rubber ball (high elastic modulus, good rebound) and FIG. 3E shows the same UTM analyzes to a ball of clay (low modulus, viscous, damping), where the cyclic analysis is repeated for the ball of clay to show further deformation each cycle (flattening, virtually no rebound). Repeat of cyclic analyses on the sensor and rubber ball simply retraces their same profiles. Though the pressure sensors are very soft and have good tack, they are also very elastomeric, which can be shown through UTM mechanical analyses and other test methods. It should be understood that the viscoelastic characteristics determined by the test results illustrated in the FIGS. 3A to 3E are only representative of only one embodiment of the sensor material described herein, and these results should not be considered limiting in any way.

FIGS. 4A to 4E show pressure sensitivity and some of the linear range of the pressure sensor in the instant invention in different scenarios of an embodiment of the pressure sensor material, and the illustrated results should not be construed as being limiting to other embodiments of the pressure sensor material. FIG. 4A shows the heartbeat pulse taken at the wrist for two individuals using one channel, where the four components of heartbeats are easily observed. FIGS. 4B and 4C show some of the linear range the sensor, with on left: A. UTM compression data and the sensor's electronic signal; and on right: B. The sensor's electronic signal as a function of load from 0 to 75 N. This is not the full range of the sensor, just a snapshot of the range up to 75 N (robotic grippers often operate around 20 N). FIGS. 4D and 4E show a comparison of the shape of an object pressing the sensor, showing trends with respect to force and force at selected depths, 2 mm/min to specified depth (−1.5 mm for flat platens on left, −4 mm for round 26 mm diameter hemisphere on right), and return at 2 mm/min to original position, for 3 cycles, with the maximum force plotted at various depths to the selected depth. This is just a snapshot of a couple of shapes and test parameters. These analyzes can be performed on a variety of shapes and objects using various test methods.

FIG. 5 is illustrative of a pressure sensor system showing a voltage source 6, pressure sensor material 4 with a flexible conductive layer 7 and electrodes 5, voltage dividers 8, an analog to digital converter 9, microcontroller 10 and host computer. FIG. 5 illustrates one embodiment of a pressure sensor system that operates to detect and display force being applied to the pressure sensor. A regulated voltage source 6 can be applied to the flexible conductive layer 7 which is in contact with the top surface of the pressure sensor material 4. The pressure sensor material 4 then acts as one end of a voltage divider 8, the other end of which is in a known resistance internal to the processing electronics. The sensor compares the resistance of the sensor material 4, which changes based on the force (or pressure) applied to the surface, with that of the known resistor using a multichannel analog to digital converter 9. This voltage data is then transmitted to a microcontroller 10 in the sensor using the SPI serial bus inside the sensor. The microcontroller interfaces with a UART conversion chip to send the voltage at each channel as USB serial data to the computer connected to the pressure sensor to be interpreted as force (or pressure) is applied to the sensor. This can provide very good first point of contact information, which can be integrated with a feedback loop back to a robotic gripper, end of arm tooling (EOAT), or prosthetic hand, to provide for the very gentle handling of objects. There are a variety of ways to capture and display the pressure (or force) sensing information, and to optimize the sensitivity of the sensor, positional and angular information of the object being handled from the sensor, to detect shear, glide, and/or slippage, and other features.

FIG. 6 shows sensing mechanisms comprising a pressure sensor pad 11 having capacitive sensing and multifrequency sensing for the pressure sensor. Using multiple alternating current (AC) frequencies 12 instead of a constant direct voltage (DC) can allow sensing information in different areas of the sensor to be captured basically all at once, for example, using Fourier transforms (FT) and FT analysis.

FIG. 7 shows one embodiment of a pressure sensor having layered components, where the bottom electrode 13 is a flat electrode. The coating(s) 14, preferably an elastomeric polymer or cross-linked network. The coating can be top layer or could surround all of the layers. The conductive layer 7, which can be a metal-based foil, weave, or twill, or carbon-based layer or weave. The soft elastic cross-linked polymer pressure sensor material 4 layer with diluents containing electrolytes. The electrolytes could be simple salts, complex salts such as ionic liquids, or a combination. The Conductive bottom layer 13, which can be a metal-based foil, weave, or twill, or carbon-based layer or weave. The baseplate 15 is preferably nonconductive, such as a standard thermoplastic. For FIGS. 7 to 10, each layer, including the cross-linked polymer layer, i.e., the pressure sensor material 4, can be very thin, from microns and nanometers, to several millimeters thick, to very thick, up to an inch or more, depending on the application. FIGS. 7 to 10 show rectangular prism shaped sensors, but these sensors can be constructed in a variety of shapes, such as more circular for health and medical monitoring.

FIG. 8 shows another embodiment of the pressure sensor having layered components, where the bottom electrode is a wire 16. The coating(s) 14 is preferably an elastomeric polymer or cross-linked network. The coating(s) can be the top layer or can surround all of the layers. The conductive layer 7, which can be a metal-based foil, weave, or twill, or carbon-based layer or weave, or a conductive wire or strand. The soft cross-linked polymer pressure sensor material 4 layer with diluents containing electrolytes. The electrolytes could be simple salts, complex salts such as ionic liquids, or a combination. The bottom electrode is a conductive wire or strand 16. The baseplate 15 is preferably nonconductive, such as a standard thermoplastic.

FIG. 9 shows another embodiment of the pressure sensor having layered components, where the bottom electrode 17 is more than one wire, such as a conductive weave. The coating(s) 14 is preferably an elastomeric polymer or cross-linked network. The coating(s) can be the top layer or can surround all of the layers. The conductive layer 7, which can be a metal-based foil, weave, or twill, or carbon-based layer or weave, or a conductive wire(s) or strand(s). The soft cross-linked polymer pressure sensor material 4 layer with diluents containing electrolytes. The electrolytes could be simple salts, complex salts such as ionic liquids, or a combination. The bottom electrodes are conductive wires or strands 17. The baseplate 15 is preferably nonconductive, such as a standard thermoplastic.

FIG. 10 shows another embodiment of the pressure sensor having layered components, where the bottom electrodes are multiple conductive areas 18, such as conductive metal pins. The coating(s) 14 is preferably an elastomeric polymer or cross-linked network. The coating(s) can be the top layer or can surround all of the layers. The conductive layer 7, which can be a metal-based foil, weave, or twill, or carbon-based layer or weave, or a conductive wire(s) or strand(s). The soft cross-linked polymer pressure sensor material 4 layer with diluents containing electrolytes. The electrolytes could be simple salts, complex salts such as ionic liquids, or a combination. The baseplate 15 is preferably nonconductive, such as a standard thermoplastic plastic, with conductive areas 18, which can vary in number and in sizes.

### DETAILED DESCRIPTION

Described herein are novel pressure sensors, also called force sensors, transducers, touch sensors, tactile sensors, or tactile skin, that have elastic properties for a fingertip-like grip feel and grip, extremely sensitive (beyond the sensitivity of a human fingertip), and yet are also tough and robust and with a very wide pressure range of use. Pressure is force divided by area. The pressure sensors described in the instant invention can also be considered force sensors, transducers, load cells, or scales or balances (weight determination). The sensors in the instant invention also attenuate force and have good creep resistance, good elasticity, and low mechanical hysteresis effects. The pressure sensors in the instant invention feel like human fingertip pads, and this is on purpose. Human grasp is gentle yet firm at the same time, due in part to the morphology of our fingertips. Muscle is used for motion, but muscle is also placed in areas of the body as pads. These areas often use passive muscle, with our fingertips being a prime example of this. The softness of the passive muscle tissue pads in our fingertips is in part what makes human grasp able to have that duality of gentle yet firm grip. Human fingertips also have a high concentration of nerve endings and are among the most sensitive areas of the human body. The nerve endings in our fingertips provides feedback to perform complex neural computations. This process of touch extracts the geometrical features of the objects we touch, such as shape, edges, hardness or softness, texture, weight, and density. The ability to replicate human like grasp in the pressure sensors of the instant invention is due in part to the morphology characteristics of the sensor material and the electronic characteristics of the sensing system, which can provide feedback. By using a combination of cross-linking agents, these sensors are multi-modal. Like cartilage, for example, this allows the pressure sensor to be able to withstand a variety of different impacts, which helps with durability and longevity.

These pressure sensors and their sensor materials (i.e., pressure sensing polymer material) provide variable resistance when subjected to mechanical pressure, even very light pressure. The sensor materials are neither pure conductors nor pure insulators, but are something in between, and so are semi-conductive with capacitive properties. Their electronic signature can be described as a variable resistor-capacitor. This variable resistive nature combined with their elastic physical nature is very useful. Pressure applied to the surface of the sensor causes a change in the geometry and properties of the sensor material. By placing electrodes in various places inside or on the surface of the sensor material, changes in resistance and capacitance caused by mechanical strain can be measured. The electrodes can be a single area or layer for each electrode (the positive and negative charged electrodes), or can be arranged in multiple areas, or a combination. When many electrodes are placed in and on the sensor material, a sophisticated understanding of the distribution of pressure on its surface from the object being handled can be determined.

The sensor material is a viscoelastic material. Even though these sensors are soft and complaint (compliant in the context of this application refers to a deformable, flexible material physical characteristic of the sensor material)—they feel like a human fingertip—and with a good amount of tack, which is beneficial for good adhesion to the electrodes, these sensors are also quite elastic. These sensors are elastomeric, with low mechanical hysteresis, low creep, and good rebound after the pressure is released.

The sensor material is not a thermoplastic, but rather, is a cross-linked network, also known as a thermoset. This provides for some unique advantages over thermoplastics. Thermosets tend to be much stronger and tougher than corresponding thermoplastics of similar composition. Typically, improving the toughness in polymers also increases their durability. Thermosets swell in solvent(s) and diluent(s), rather than dissolving into solution like a thermoplastic. Thermosets typically cannot be melted and reformed, while thermoplastics are melted and then cooled into desired shapes through injection molding and other methods. Once a thermoset has set or cured, which can be in a mold, that is its final shape. The cross-linking strategy for fingertip-like pressure sensors in the instant invention provided for sensor materials that were: 1) Soft and slightly elastomeric, and with good rebound after mechanical pressure, i.e., low hysteresis and low creep; 2) with adequate conductance to be easily measured electronically; and 3) low enough electronic hysteresis after the release of mechanical pressure for good signaling outputs.

By constructing pressure sensor pads using an elastic conductive sensing material, immediate feedback is generated at the first point of contact, allowing the force applied to the object to be finely controlled. Because these pressure sensors provide for a soft compliant elastic interface, the first point of contact does not apply excessive force. The pressure sensor can also detect a change in pressure location on its surface, making it possible to detect and prevent slippage by then adjusting the grip strength. In other words, directional glide can provide feedback on the presence of slippage to then control a slightly tighter grip, due to both the feedback and the soft gentleness of the pressure sensor pads themselves. The elastic nature of the sensor material acts as a fingertip-like pad that naturally holds the gripped object, improving gripping quality over rigid robotic grippers and end of arm tooling (EOAT) without an increase in applied force.

The pressure sensor material(s) is comprised of cross-linked networks, produced by ultraviolet (UV) photo-polymerization of hydrophilic monomers with selected cross-linking agents, using any appropriate commercially available photo-initiator like Irgacure® 184 (1-hydroxycyclohexylphenyl ketone, Ciba, Aldrich and other suppliers). The UV source can be a UVitron® SunRay 600 W 175 mW/cm2 UVA (320-390 nm) array operated at the lower setting. The desired pore sizes and elasticity in the final networks were achieved by controlling the cross-link density and solvation during polymerization. Other free radical and excited state initiators can be used, such as benzoyl peroxide, azobisisobutyronitrile (AIBN), and others. Other energy sources for the polymerization can be used, such as heat (infrared radiation), visible light, gamma ray radiation, microwave energy, and others. A mixture of cross-linking agents was used to produce multi-modality in the sensor materials, in order to provide good material integrity and toughness over a wide range of mechanical pressure inputs. The poly(ethylene glycol) (PEG) dimethacrylate based cross-linking agents helped provide elasticity, while silicone containing cross-linking agents in particular helped provide toughness (plus some elasticity) in these sensors and their sensor materials.

A variety of solvents and diluents, can be used. It is important for the operation of the pressure sensor that the polymer material comprising the pressure sensor be comprised of a solvent and diluent that does not evaporate (like water does) over time. In this regard, water is not used as a solvent or diluent for this pressure sensor polymer material. Two diluents that can be used are glycerin, also known as glycerol, and low molecular weight poly(ethylene glycol) (PEG) such as PEG-200. These diluents can be used singly or in combination. PEG-200 has a density close to water, 1.124 g/mL compared to 1.000 g/mL for water, so was used for the pressure sensors in the instant invention, but other PEG and polymeric diluents could be used to provide a variety of properties as desired.

These novel pressure sensors can conduct low levels of electricity at the atomic level. Electrolytic salts, including simple salts such as sodium chloride and potassium chloride, and ionic liquids (ILs), such as 1-butyl-3-methylimidazolium hexafluorophosphate, provided good conductance in the sensor material. The conductance of the sensor material can be controlled as desired during synthesis by adjusting the concentration of salt(s), ionic liquid(s), or a combination. Resistance, the inverse of conductance, was measured in these EAPS using a digital multi-meter, an oscilloscope, and other methods. The resistance of the soft sensors was easily matched to the appropriate resistors used in the circuitry for pressure sensing. Likewise, resistors can be matched to the synthesized sensor materials. Potentiometers can also be used to determine the best resistor-sensor material match, and adjustable potentiometers can be incorporated into the printed circuit boards (PCBs) of the sensing devices and sensing systems and their controllers. As previously described with respect to FSRs, micron and nanometer level conductive additives are added to a polymer matric to provide for variable conductance, with investigators using smaller and smaller nanoparticles. A level even smaller than these nanoparticles is at the Angstrom level, i.e., the level of atoms or ions at the atomic level. Because the conductive moieties in the instant invention, dissolved electrolytes, ionic liquids, or a combination, are part of the sensor material at the atomic level, rather than particles, this provided a wide range of pressure detection, rather than the sharp jumps observed in typical force sensitive resistors (FSRs). This is a profound advantage over traditional pressure sensors. The sensors in the instant invention have the ability to detect extremely small pressure and forces, withstand high mechanical pressures and forces, and have proportionality over a wide pressure range.

The pressure sensor according to one embodiment is comprised of an elastic, semi-conductive, cross-linked polymeric sensor material with appropriate electrodes, and a coating(s). The pressure sensor material is comprised of a cross-linked polymeric material (also known as a cross-linked network, infinite network, or gel), which is a hydrophilic monomer, polymerized and cross-linked with at least one cross-linking agent, and with at least one diluent or solvent (which could be incorporated before, during, or after the polymerization), low molecular weight poly(ethylene glycol), glycerol (also known as glycerin), or other similar diluents, and any combinations thereof, and with at least one salt or electrolyte, where the sensor has conductive layers or conductive pins or conductive areas (i.e., electrodes), top and bottom, or embedded within the sensor material, which could be carbon or metal based and which could be single or multi-channeled, and optionally, the sensor has a coating(s) to help protect the sensor material (cross-linked polymeric material) and the conductive layer(s), pin(s), area(s), or combination thereof.

The hydrophilic monomer(s) for the pressure sensor material can be selected from a group consisting of poly(methacrylic acid), poly(2-hydroxyethyl methacrylate), poly(vinyl alcohol), ionized poly(acrylamide), poly(acrylic acid), poly(acrylic acid)-co-(poly(acrylamide), poly(2-acrylamide-2-methyl-1-propane sulfonic acid), poly(methacrylic acid), poly(styrene sulfonic acid), quartemized poly(4-vinyl pyridinium chloride), poly(vinylbenzyltrim-ethyl ammonium chloride), sulfonated poly(styrene-b-ethylene-co-butylene-b-styrene), sulfonated poly(styrene), and combinations thereof. The cross-linking agents can be selected from a group consisting of poly(dimethylsiloxane) (PDMS) dimethacrylate, a poly(ethylene glycol)dimethacrylate, an ethylene glycol dimethacrylate, 1,1,1-trimehtylolpropane trimethacrylate, and combinations thereof. The polymer material comprising the pressure sensor can have a diluent selected from a group consisting of poly(ethylene glycol) with a molecular weight around 200 g/mole, glycerin, also known as glycerol, and combinations thereof. The polymer comprising the pressure sensor can have an electrolyte selected from a group consisting of Group 1 and Group 7A salts, Group 1 and Group 6A salts, Group 2 and Group 7A salts, Group 2 and Group 6A salts, Group 1 and carbonate salts, Group 2 and carbonate salts, Group 2 and sulfate salts, Group 2 and sulfate salts, ionic liquids, and combinations thereof. The pressure sensor's coating(s) can be an elastomeric material, such as silicone, but could also be polyurethane based or comprise another flexible material, or combinations thereof.

According to one embodiment, conductive ultrafine carbon particles, such as Cabot® Vulcan™ carbon particles, were employed for the sensor material. With particulate carbon, pressure sensing only came into play at extremely high mechanical pressures, and then a jump (basically like a force sensitive resistor was observed), but this may have some value to provide for pressure sensors that need an extremely wide range of operation. The particles could be carbon or metal based, and micron or nanometer sized, depending on the application.

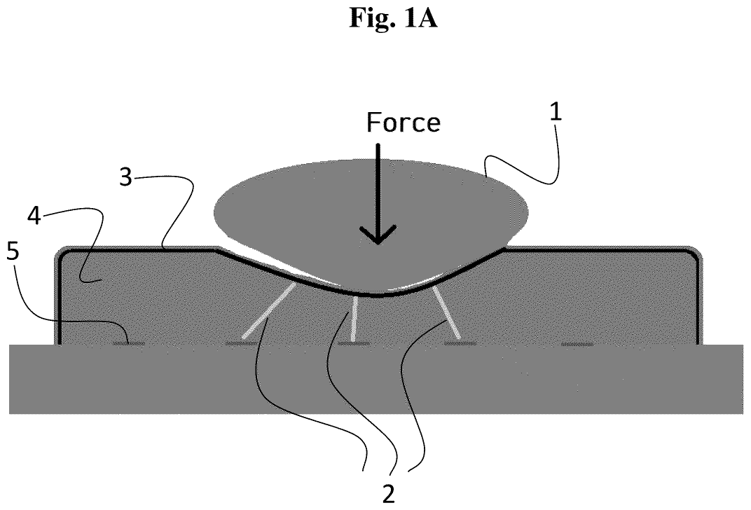

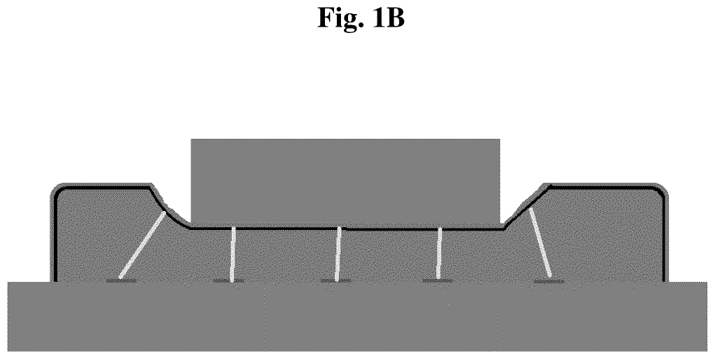

The pressure sensor in the instant invention is comprised of a four-layer structure, where the first layer is comprised of a thin flexible and robust silicone or other elastomer, which is used to protect the rest of the sensor, and to provide a uniform and durable contact surface. Any flexible, durable material can be used for this top layer, which serves as a flexible protective coating. The second layer is comprised of a carbon fiber fabric which is electrically connected to the sensing circuitry. Any material that is both flexible or elastic and highly conductive can be used in this layer. The third layer is comprised of the cross-linked polymeric sensor material, which is electrically and mechanically connected to the conductive layer above it. The fourth layer is comprised of a flat, rigid, insulating surface, on which is embedded a conductive layer or an array of electrodes, all of which are connected to the underlying circuitry. This array of electrodes allows the sensing circuitry to determine the electrical properties of the sensor material at various different locations. The cross-linked polymeric sensor material is a formulated in order to create a low noise, high accuracy force transducer. This sensor material's characteristics are neither pure conductors, nor pure resistors, but something in between. When subjected to mechanical force, the electrical characteristics of the pressure sensor material changes: 1) the combination of ion-containing, polar, or hydrophilic polymer groups on the cross-linked polymeric material and the free charge carriers in the diluent(s)'s solution create a material with uniform electrical characteristics with a moderately high resistance, which can be varied depending on the exact formulation and manufacturing conditions (typically 50 kOhm to 1 MOhm), where the moderate resistance and low charge mobility mean that the electrical signal transmitted through the material are very low noise and are resistant to electromagnetic interference; 2) deformation from pressure causes changes in the electrical characteristics, which are both highly linear with strain applied and low noise—the composition and manufacturing conditions of the cross-linked polymeric sensor material can be altered to change the hardness of the material, leading to different correlations between applied stress and strain, thus the material can be used to create highly accurate force and pressure transducers which operate over many force ranges in both tension and compression; 3) the first point of contact (first touch) can be readily and near instantaneously detected, due to the sensitivity (low signal to noise) and the speed (low latency) of this novel pressure sensor; 4) when pressure is applied to the surface, deformation of the sensor occurs, and the distance between the conductive surface and the electrodes on the bottom of the sensor material changes, which causes the electrical resistance and capacitance measured at each of the electrodes to change, where these changes can then be interpreted to learn information about the position and shape of objects in contact with the surface of the sensor: 4A) using the measured change in voltage between the electrodes, the sensor can determine the location of the primary contact of an object; 4B) the ratios of the electric signals can also be used to determine size and shape of an object, for example, in the bottom diagram in FIG. 1, the three middle electrodes show similar readings, indicating that the object is flat, and the reading from both of the outer channels indicate that the object has a large contact surface area; 4C) once an object has been grasped, the sensor can be used to determine the direction and magnitude of forces applied to it, for example, when a force is applied, the position of the object will move inside the soft grip of the sensors, where this change in position can be mapped to indicate shear force and torque; and 4D) the low number of data-points, but high accuracy data, make the sensor a prime candidate for machine learning techniques, where instead of writing analytical algorithms to identify force, shape, position, and area, an automatic testing device is used to build a number of machine learning based models to predict features about objects contacting the novel sensor.

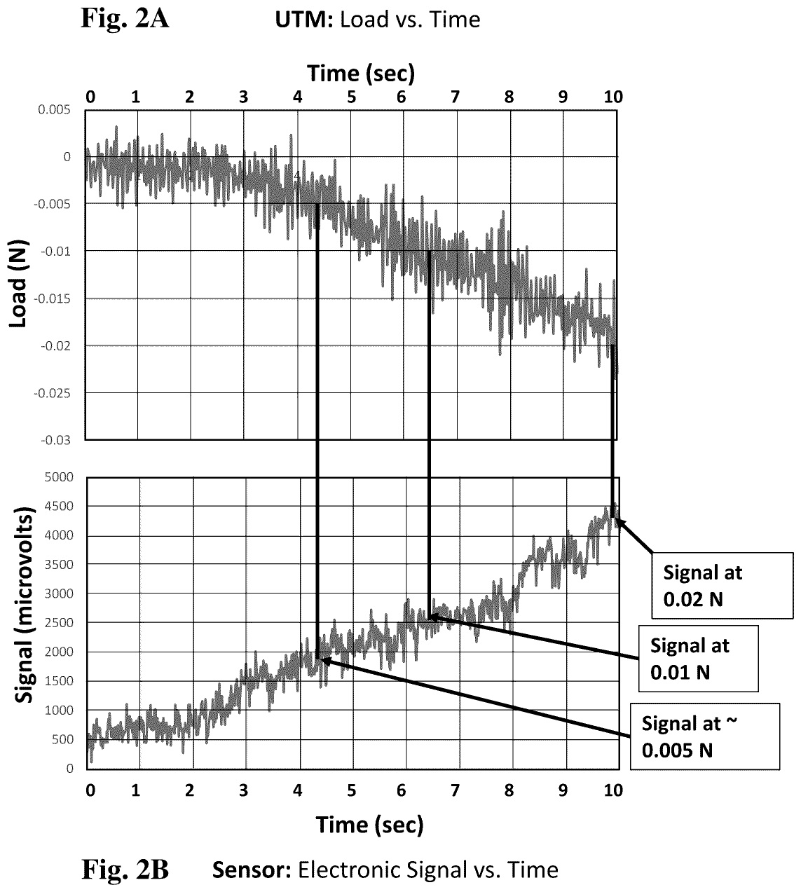

The pressure sensors according to an embodiment have been tested and found to be extremely sensitive (FIG. 2). In compression, small changes in pressure could be picked up by the sensor as well (good signal to noise, much better than the load cell). By making the sensor material thinner and/or expanding the electrode areas, the sensors could provide even greater extreme sensitivity.

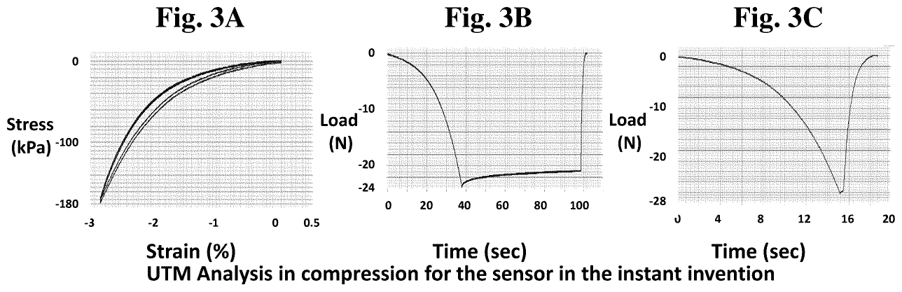

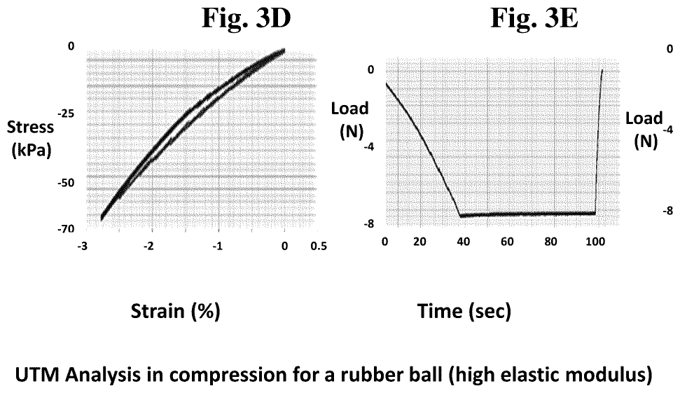

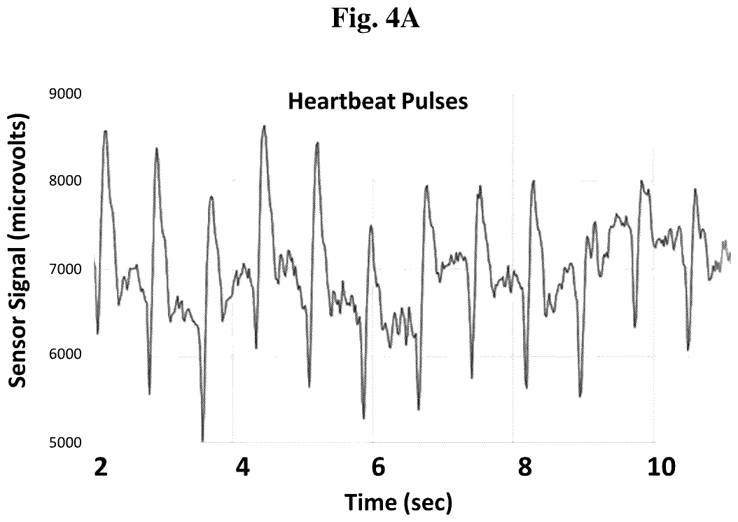

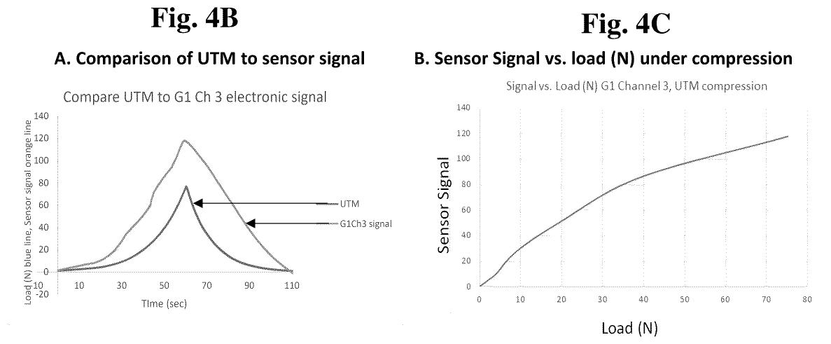

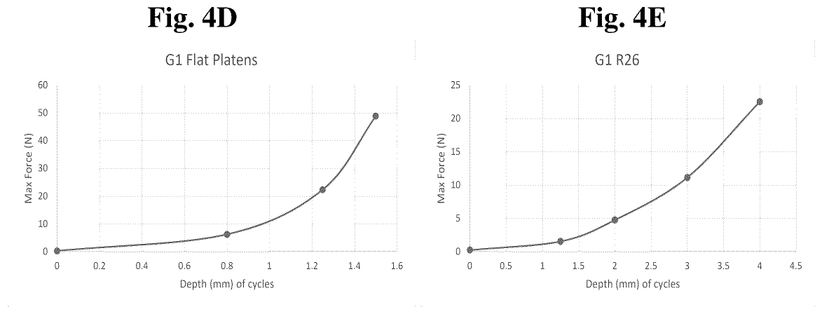

The pressure sensors described herein have a wide pressure range. The soft sensor material is partly what makes the grip of these pressure sensors so unique, but good elasticity, i.e., the ability to quickly rebound back to their original position after the pressure is removed, is also very important. This elasticity allows the sensor to be able to reliability sense the next object being gently gripped. Though these sensor materials are viscoelastic, these sensors are very elastic for such a soft matrix (FIG. 3). The sensor's electronic signal is substantially linear when compressed under high loads, so have a wide pressure range as well (FIG. 4).

The soft nature of these pressure sensors and other factors in the formulations such as the diluent(s) used, also can provide good tack, which is important for good adhesion of the sensors material to any electrode(s) (and the baseplate). These formulations with their good tack and adhesion were also found to be self-healing, which may be in part why the pressure sensing polymers, materials, devices, and systems in the instant invention were observed to be so extremely robust and durable. These pressure sensors survived over 20,000,000 fatigue cycles, including in shear force (20,000,000 cycles was not to failure, the fatigued pressure sensors are still working well). Self-healing polymers have the intrinsic ability to automatically repair damage to themselves by countering degradation through the initiation of a repair mechanism(s) that responds to formation of micro-damage such as cracks and other types of damage at the microscopic level.

There are many materials that are soft and with high tack (stickiness), for example, glues and adhesive. Most soft, compliant (low modulus) materials aren't very elastic, while most elastic (rubbery) materials don't have much tack and aren't very soft or very compliant. The pressure sensors and the pressure sensor's materials in the instant invention can be soft and compliant, much like a human fingertip, can have tack for good adhesion, can have elasticity (good rebound when pressure is released), and can have electronic characteristics for sensing pressure and/or force (and/or weight). These pressure sensors can be extremely sensitive, but they also have a wide pressure range, in part because of the pressure sensor material's unique softness/compliance and elasticity. The formulations for the pressure sensor material can be tailored as needed for various applications.

Increasing the number of negative electrode areas (like pins) on the bottom plate of the sensor is expected to be able to easily determine more defined spatial information. In the printed circuit board (PCB), the current limiting resistors in series with the sensor material can be increased to more closely match the sensor material and to lower the current flow over the entire system. This allows the sensor to be able to operate continually much longer (days) without a rest, reset, or calibration step and increase its total operating lifetime. Adding an optional gate to ground can also be added to the PCB so that a reset or calibration step can be provided as needed. Optionally, a gated pathway for a short reverse polarity step can be added to serve as a full reset as needed. Gold plated electronic pins and other common options can be used for the negative electrodes.

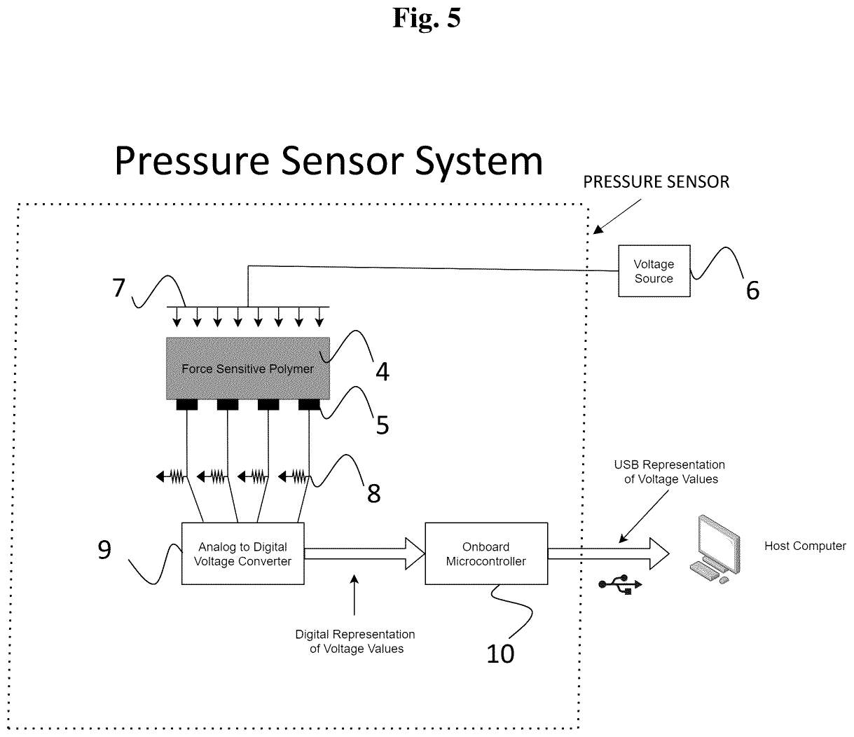

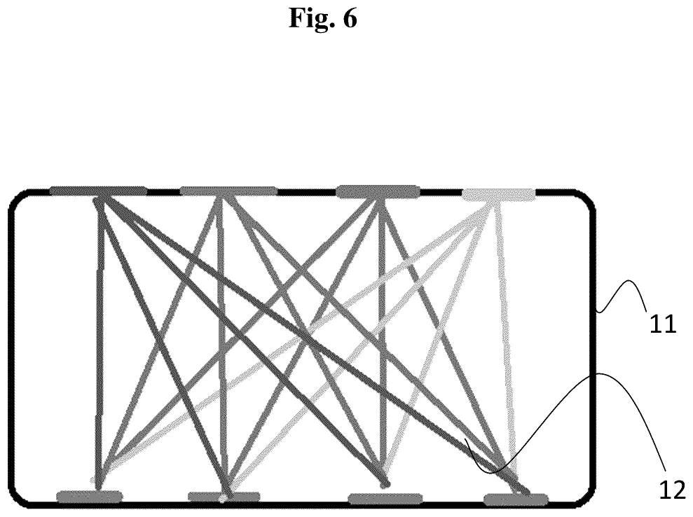

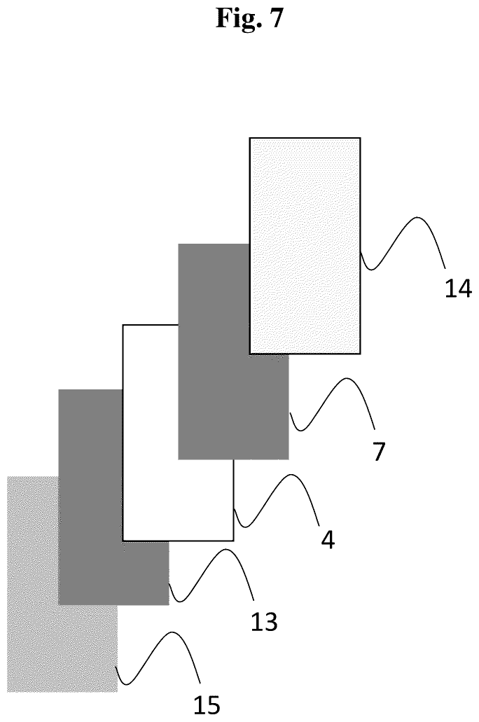

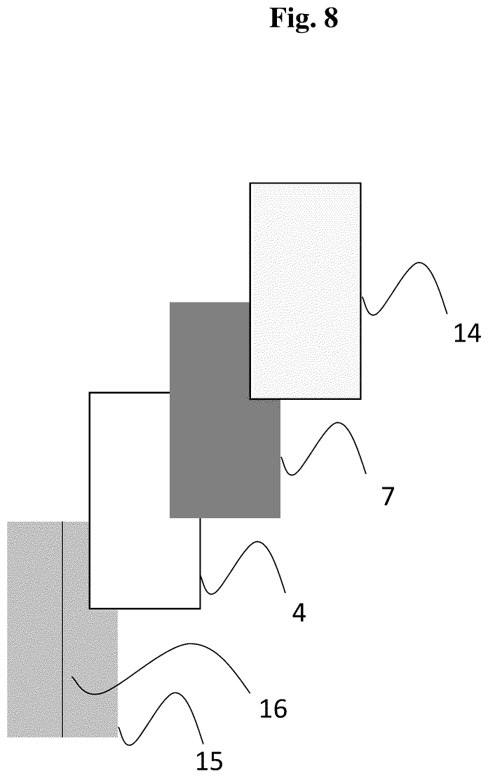

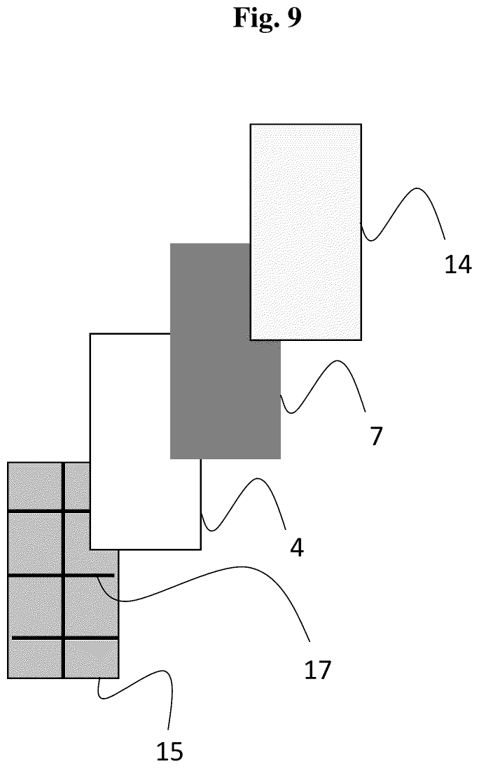

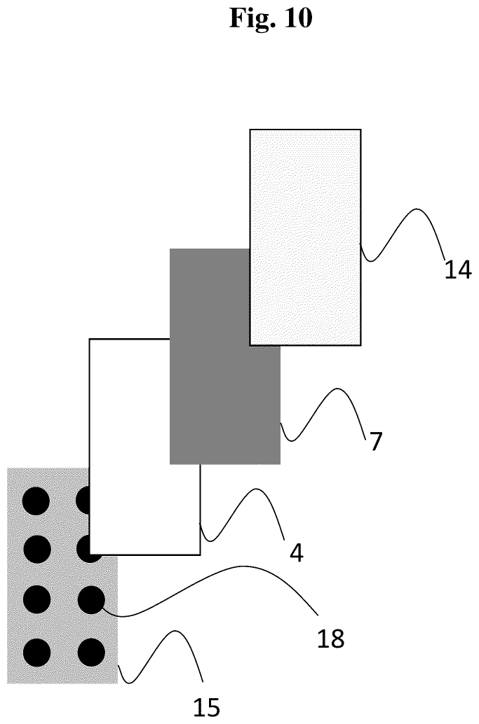

In the pressure sensor of the instant invention, one way to capture and display the electronic information from the pressure or force sensing is as follows (FIG. 5): A regulated voltage source can be applied to the flexible conductive layer, which is in contact with the top surface of the pressure sensor material. The sensor material then acts as one end of a voltage divider, the other end of which is in a known resistance internal to the processing electronics. The sensor compares the resistance of the sensor material, which changes based on the force (or pressure) applied to the surface, with that of the known resistor using a multichannel analog to digital converter. This voltage data is then transmitted to a microcontroller in the sensor using the serial peripheral interface (SPI) serial bus inside the sensor. The microcontroller interfaces with a universal asynchronous receiver-transmitter (UART) conversion chip to send the voltage at each channel as Universal Serial Bus (USB) serial data to the computer connected to the pressure sensor to be interpreted as force (or pressure) is applied to the sensor.

In addition to being able to determine the first crucial point of contact of an object with the pressure sensor, there is a richness of information that can be extracted from these fingertip-like sensors develop this technology into intuitive human-like tactile touch. Human grasp is simultaneously gentle yet firm, is intuitive, and is loaded with tactile touch information. The sensor is able to determine several characteristics of the of an object in contact with is including, center of contact, an estimate of object shape, and direction and magnitude of force being applied to the sensor. The softness or hardness of an object being handled or manipulated can also be determined using these pressure sensors. This information can be extracted using a machine learning (ML) recognition algorithm to classify different types of shapes and determine force and position by drawing on past data. The sensor is initially soft but becomes firmer once solid contact has been made, much like the human grasp. It also learns to identify object and grasp characteristics by learning many examples in a similar way as humans do. A fatigue test rig was used to produce datasets with a variety of shapes to test for consistent signal consistency over time. ML was performed along with artificial intelligence (AI) integration. To allow the sensor to predict force independent of shape or size of the object causing that force, the testing apparatus applied force to the sensor with different shapes while changing the position, angle, and amount of force. This training set is then processed by a neural network to teach the sensor how to identify force and position independent of the shape of the object applying that force. Some shapes used in the training set were spheres, flat objects, and cylinders over a range of sizes and curvatures to simulate those objects a sensor is most likely to deal with in operation, as well as triangles and other training shapes. To provide correct data to the machine learning algorithm, a geometric analysis program was created to determine the point of contact between each object and the sensor. Algorithm modeling and shallow learning were first explored, and neural networks were started: Several ML tooling methods were investigated, including k-nearest neighbor and random forests, as well as convolutional neural networks to extract position, force, and shape data from the sensor. ML and AI can be layered into the sensor systems, however, even with these add-ons for more intuitive feedback, these sensor systems are consistent, reliable, and can be made as simple as possible to maintain low latency, i.e, to keep the feedback speed near instantaneous in real time without delays. Concerning glide feedback to prevent slippage, there could be a fast feedback loop without much ML and AI, while for more sophisticated tasks and motion, ML and AI could be more fully employed. The analogy is when our hand feels pain, we immediately jerk our hand back because of the faster response from the spinal cord feedback loop, while the more delayed interpretation of pain and analysis comes from the brain's feedback loop. This quick feedback loop helps prevent injury, while for more sophisticated tasks like fine craftsmanship, most of the feedback to our hands is cerebral. The combination of a fast feedback loop for point of contact and glide or shear and ML/AI integration for the more complex understanding and EOAT manipulation of objects, using these novel sensing features, is creating the possibility of robotic grippers and EOAT with human hand-like dexterous control and tactile touch sensing.

This invention describes a pressure sensor, device, or system, which can act as a force sensor or a touch sensor or a tactile sensor or skin, comprising hydrophilic monomer(s), cross-linked with appropriate cross-linking agent(s), with appropriate nonaqueous solvent(s) or nonaqueous diluent(s), electrolyte(s), electrodes, and coating(s). These pressure sensors can be made in a variety of shapes and sizes as desired. With soft compliant pressure sensors that can detect down to 0.01 N and lower, and are also robust and with a wide pressure range, the pressure sensors in the instant invention can be used in a variety of applications, from robotic grippers, EOAT, and robotic and prosthetic hands, to medical sensing and sports equipment, and other applications. Another observation happened while testing these sensors. What we thought was an electronic artifact, was the pressure sensor in the instant invention picking up the heartbeat pulse in our fingers when we were holding the sensors during testing (could even see the atrioventricular-semilunar two parts of the heartbeat pulse, FIG. 4). By combining the absolute values of all the signals from the bottom negative electrodes into one signal, sensitivity could be improved even greater. Human fingertips can sense down to 0.1 N, which this technology surpassed.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A pressure sensor, comprising:
An elastomeric, semi-conductive material having a specified thickness which is comprised of a first surface area to which is attached at least one first conductive element, and a second surface area that is in contact with at least one second conductive element, wherein the second surface area is separated from the first surface area by a distance that is less than or equal to the specified thickness of the elastomeric, semi-conductive material; and
a voltage source is electrically connected to the at least one first conductive element attached to the first surface area, and a voltage measuring device is electrically connected to the at least one second conductive element in contact with the second surface area and operates to measure a voltage at the at least one second conductive element that corresponds to a pressure applied to the elastomeric, semi-conductive material.

2. The pressure sensor of claim 1, wherein a flexible protective coating covers at least a portion of the first surface area comprising the pressure sensor.

3. The pressure sensor of claim 2, wherein the flexible protective coating is an elastomeric polymer material.

4. The pressure sensor of claim 1, further comprising a flat, rigid base composed of an electrically insulating material that is attached to the second surface area.

5. The pressure sensor of claim 1, wherein the at least one first conductive element is comprised of a flexible, electrically conductive material.

6. The pressure sensor of claim 1, wherein the at least one first conductive element is comprised of a plurality of electrodes, each being connected to the same regulated voltage source.

7. The pressure sensor of claim 1, wherein the at least one first conductive element is comprised of a continuous sheet of the flexible, electrically conductive material.

8. The pressure sensor of claim 1, wherein the at least one first conductive element is comprised of a mesh sheet of the flexible, electrically conductive material.

9. The pressure sensor of claim 1, wherein the at least one second conductive element is attached to or embedded in the surface of the flat, rigid, electrically insulating material.

10. The pressure sensor of claim 1, wherein the at least one second conductive element is any one or more of a continuous sheet of electrically conductive material, an array of a plurality of electrodes, electrically conductive material arranged in a woven pattern, and a single, electrically conductive wire.

11. A method for producing a novel, advanced, superior pressure touch sensing polymer, pressure touch sensing polymer material, pressure touch sensing device, and pressure touch sensing system from reactants comprising:
(a) at least one ion-containing monomer;
(b) at least one cross-linking agent, with a functionality of 3 or greater;
(d) at least one diluent compatible or miscible with said ion-containing monomer; where the diluent(s) is not water;
(e) at least one electrolyte;
(f) polymerizing and cross-linking said reactants to produce said pressure touch sensing polymer or material of said pressure touch sensing device; and
(g) placing electrodes above and below pressure touch sensing polymer or material, including placement even immediately after polymerization, or on one side and the other side of said pressure touch sensing polymer or material of said touch sensing device.
